(19) United States
(12) Patent Application Publication
(10) Pub. No.: US 2003/0164649 A1
(43) Pub. Date: Sep. 4, 2003

(54) Integral motor having a multidimensional shaft for rotary scanners

(75) Inventor: Tung Choi Cheng, Markham (CA)

Correspondence Address: CYM GRAPHICS INC., 1271 DENISON ST., UNIT 47, MARKHAM, ON, L3R 4B5, CA

(73) Assignee: Cym Graphics Inc., Markham (CA)

(21) Appl. No.: 10/086,563

(22) Filed: Mar. 4, 2002

(51) Int. Cl. H02K 15/00

(52) U.S. Cl. 310/42

(57) ABSTRACT

An integral motor having a multidimensional shaft to allow a rotary scanner to consistently rotate the cylindrical transparent rotary drum for an optical system to sample the original mounted on the rotary drum. A rotary scanner converts analog data collected from the original to digital information for processing in a computer. The integral motor fixed and supported by two brackets comprises a multidimensional shaft attached to a rotor padded by two bearings inside a shield, a stator attached to inside wall of the shield with ends covered by two bore covers and a magnetic field sensor attached to the stator. The stator, the rotor and the magnetic field sensor of the integral motor, applying direct rotation on the multidimensional shaft, permit precise positioning of the rotary drum.

### REFERENCES CITED U.S. PATENT DOCUMENTS

4870504 9, 1989 Ishikida et al . . . 358/489

5317424 May, 1994 Aotani . . . 358/491

5535061 Jul., 1996 Johnson et al . . . 359/872

6023348 Feb., 2000 Bosse et a . . . 358/489

6102807 Aug., 2000 Barrett et al . . . 464/180

6121700 Sep., 2000 Yamaguchi et al . . . 310/68

6340854 Jan., 2002 Jeong . . . 310/90

### BACKGROUND OF THE INVENTION

The present invention relates to rotary scanners, and more particularly to an integral motor having a multidimensional shaft for rotating a rotary drum.

A rotary scanner operation involves an optical system decoding analog signals from an original mounted on a rotating rotary drum. Rotary drums are rotated by the motors. Two common prior designs for driving the rotary drum of a rotary scanner are the method of the belt drive motor and the method of the external motor.

Referring to FIG. 1, the illustrated belt drive motor propels with a motor unit 470 and a rotary drum 471 attached together by a belt 474 connecting the motor's shaft 472 with the rotary drum's shaft 473. Rotational forces are transferred through the belt 474. Three problems exist for this prior art motor. First, the belt 474 material may expand or contract due to temperature; second, the belt 474 material is elastic thus existing tension may cause vibrations to the rotary drum 471; third, the belt 474 material may contribute to unbalanced rotation speed of the rotary drum 471.

Referring to FIG. 2, the external motor shown has its motor unit 460 connected to a rotary drum 461 by a conjunction unit 464. Rotational forces are transferred through the conjunction unit 464 from the motor's shaft 462 to the rotary drum's shaft 463. In other words, the conjunction unit 464 rotates with the motor's shaft 462 and the rotary drum's shaft 463. Three problems are associated with this prior art motor. First, the design takes up too much space; second, the design is complex in the method of aligning the rotary drum's shaft 463 with the motor's shaft 462 precisely at their center points; third, vibrations of the rotary drum 461 exist due to the conjunction unit 464 design.

Any one of the above mentioned problems associated with the belt drive motor and the external motor may reduce the rotary scanners' scan quality dramatically.

### BRIEF SUMMARY OF THE INVENTION

It is an object of the invention to provide an integral motor for rotary scanners that overcomes the aforesaid problems.

Further, it is an object of the invention to enhance the stability and performance of a drum motor.

Furthermore, it is an object of the invention to minimize the noises produced from any connections between a drum motor and a rotary drum.

Still a further object of the invention is to reduce the overall size of a drum motor.

Additional, it is an object of the invention to use more economical and efficient mechanics to build drum motors in order to lower the cost of rotary drum scanners.

In accordance with the present invention, an integral motor, cylindrical in nature, is formed from a multidimensional shaft supported and fixed by two brackets padded by bearings and rotated by a stator, a rotor and a magnetic field sensor in a shield with ends covered by bore covers.

Multidimensional shaft means a cylinder form with numerous diameters on an axle. Bracket means an L-shaped structure for supporting and securing the integral motor to the base. Bearing means a pad for the multidimensional shaft to separate the base support from the multidimensional shaft to eliminate rotational friction damages. Rotor means a device of a hollow cylindrical arrangement of permanent magnets. Stator means a device of a hollow cylindrical arrangement of coils. Magnetic field sensor means a device to detect magnetic polarity. Shield means a hollow round tube. Bore cover means a piece of metal to cover the ends of the shield secured by cavity in the bearing.

The disclosed objects of the present invention are achieved by the multidimensional shaft having numerous different diameters of the integral motor. Achieving all angles between different diameters on the multidimensional shaft in right angles, different components of the integral motor can align precisely using the perpendicular edges of the multidimensional shaft. Another advantage of the numerous different diameters design is the multidimensional shaft's thicker end passing through the rotary drum. This can provide a maximum rotational force to the rotary drum and to save energy wasted on the other end of the multidimensional shaft.

Another object is achieved by directly attaching the multidimensional shaft of the integral motor to the rotary drum. The multidimensional shaft is supplied with rotational force by the stator, the rotor and the magnetic field sensor, which are installed inside its shield. The self-rotating multidimensional shaft connects directly to a rotary drum. The rotary drum rotates free of vibrations. Vibrations are usually generated by belt drive method. As well, the integral motor saves a lot of space without any extra conjunction units.

Further objects of the integral motor are achieved by the placements of the rotor and the stator. According to the present invention, the rotor of the integral motor is the arrangement of permanent magnets insert to the multidimensional shaft. The stator is positioned surrounding the rotor without contact. The magnetic field sensor is fastened and then is aligned and centred to stator. The rotation force for the multidimensional shaft is induced by changing the polarity of magnetic field implement by the magnetic field sensor to the rotor and coils of the stator. There is no conductor or other component needed in mechanical contact with the rotor. So the integral motor does not generate sparks and has no wear and tear of its material. As a result, the integral motor has a very stable and reliable performance.

### BRIEF DESCRIPTION OF THE DRAWINGS

The preceding and other objects and characteristics of this invention will be apparent hereinafter from detailed description of the invention in accordance with supplementary drawings in which:

FIG. 1 is a side view of a belt drive motor;

FIG. 2 is a side view of an external motor;

FIG. 3 is a perspective view of an integral motor incorporating a rotary drum, an original, a drum base, a lock ring, a shield, two bore covers and two brackets;

FIG. 4 is a side view of a multidimensional shaft with all diameter differences in right angle;

FIG. 5 is cross-sectional side view of an integral motor without its bore covers and brackets to show the interior mechanics inside the integral motor; and

FIG. 6 is a side view of an integral motor showing the positioning of the multidimensional shaft inside the integral motor.

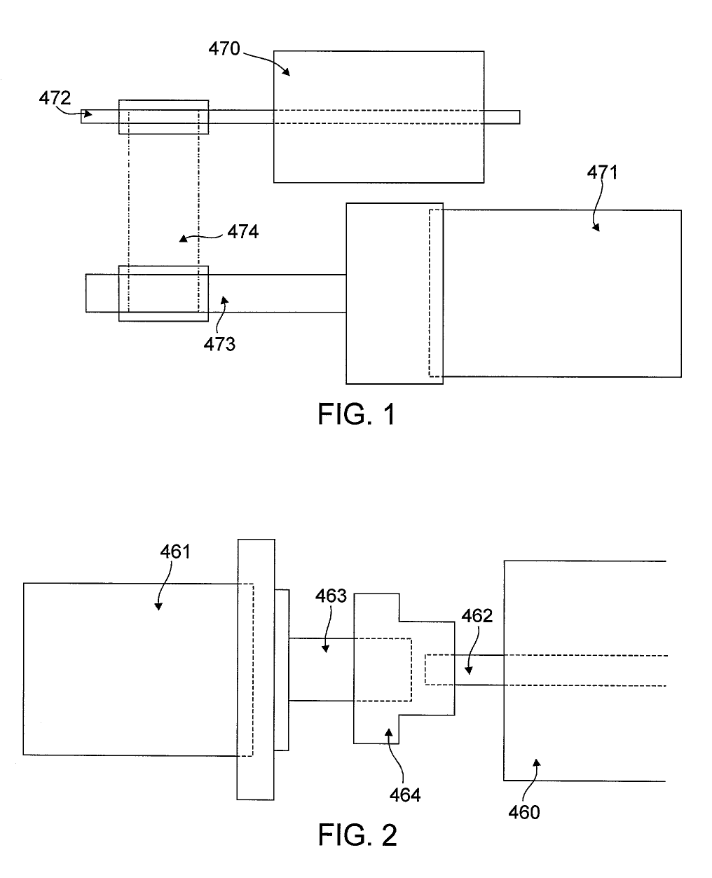

### DETAILED DESCRIPTION OF A PREFERRED EMBODIMENT

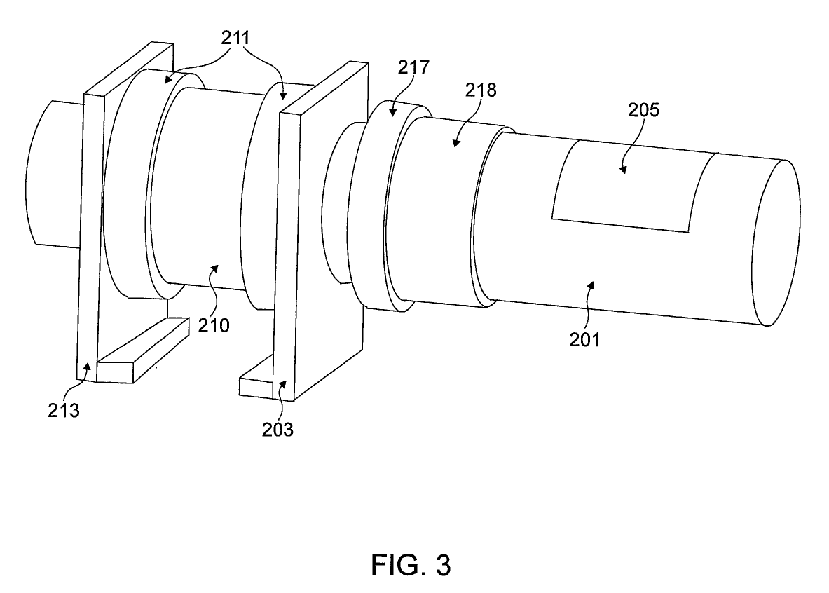

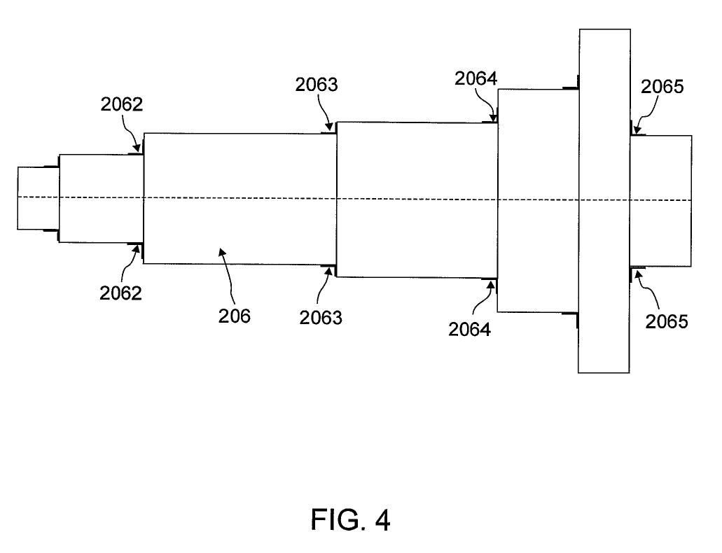

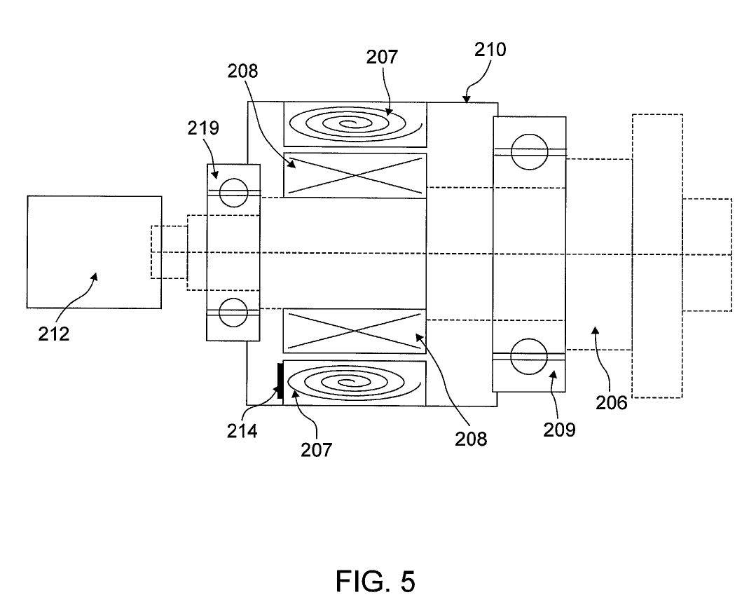

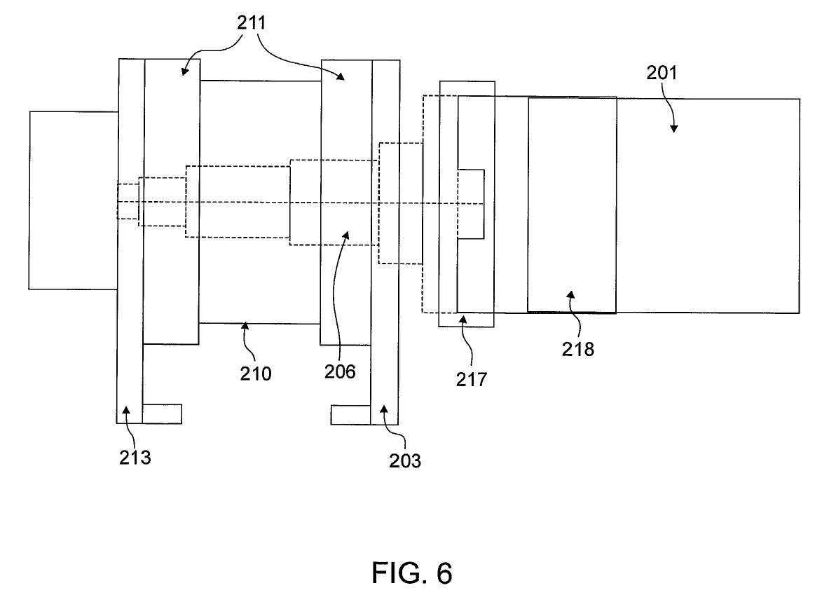

The preferred embodiment of the present invention will be described hereinafter in accordance with FIG. 3, FIG. 4, FIG. 5 and FIG. 6. Reference numberings of same components are identical across all figures.

Referring to the drawings, FIG. 3 shows a drum base 218 with a rotary drum 201 connected to the integral motor by a lock ring 217 securing them together. To sample an original 205 using the rotary scanner, the rotary drum 201 is rotated by an integral motor while an optical system moves gradually to collect data from the rotating original 205. Two brackets 203, 213 are provided for supporting and securing the integral motor to the rotary scanner base. The left bracket 213 has a right read L-shape while the right bracket 203 has the L-shape reversed horizontally. The bottom side of each of the brackets 203, 213 is fastened to the rotary scanner base and the upright side of the brackets 203, 213 is fastened to the outer surface of the bore covers 211.

Referring to FIG. 4, a multidimensional shaft 206 is shown having numerous diameters on its axle. Each increment in the multidimensional shaft's 206 diameter is direct, and the numerous dimensions of the multidimensional shaft 206 are processed mechanically at the same center point. In other words, these direct increments of the multidimensional shaft's 206 diameter result in perfectly perpendicular surfaces and linearly aligned at the same center point on the multidimensional shaft 206 between each diameter increment. Edges of the multidimensional shaft 206 are numbered as reference position markers for locations of the integral motor components illustrated in FIG. 5 and FIG. 6. The multidimensional shaft 206 lies horizontally across the center of the shield 210. The thicker diameter on the right of the multidimensional shaft 206 is directly connected to the rotary drum 201 that consists of a heavier load, whereas the thinner diameter on the left of the multidimensional shaft 206 consists of a lighter load.

Referring to FIG. 5, the integral motor is shown having the multidimensional shaft 206, a stator 207, a rotor 208, two different size bearings 209, 219, a coupling 212, a magnetic field sensor 214 and a shield 210. These components are the interior mechanics of the integral motor. Referring to the position markers in FIG. 4, the rotor 208, bearings 219 and 209 are forced to press and fix to the specific edges of the multidimensional shaft 206 by the cavity from the left side. The rotor 208 is aligned on the multidimensional shaft edge 2063. The bearing 209 is aligned on the multidimensional shaft edge 2062. The bearing 219 is aligned on the multidimensional shaft edge 2064. These three components, which inner diameters are slightly larger than the outer diameters of the multidimensional shaft 206, are assigned to their respective positions. In other words, each components of their center point are linearly and vertically aligned to the center point of the multidimensional shaft 206 while these three components are horizontally inserted to the multidimensional shaft 206.

The shield 210 is a cylinder form, which is the shell of the multidimensional shaft 206 aligns horizontally with the multidimensional shaft's 206. Its position is fixed by the bore covers 211 illustrated in FIG. 6. The stator 207 is positioned surrounding the rotor 208 and attached onto the inside wall of the shield 210. There is a tiny gap between the stator 207 and the rotor 208 to allow the rotor 208 to rotate freely with the multidimensional shaft 206 and for the magnetic field to be transferred. The magnetic field sensor 214 is fastened to the perpendicular surface of the stator 207 by screws. The coupling 212 is secured firmly to the left end of the multidimensional shaft 206 with its center point aligning linearly with the multidimensional shaft 206.

FIG. 6 is the exterior of FIG. 5 illustrating the multidimensional shaft 206, the shield 210, a lock ring 217, a drum base 218, two brackets 203, 213 and two bore covers 211. For connecting the right end of the multidimensional shaft 206 to the rotary drum 201 linearly, the rotary drum 201 is first inserted tightly into the drum base 218 by precise diameters fit. The drum base 201 mean a segment, one end is concave for embracing rotary drum 201; other end is convex which is connect to the multidimensional shaft 206 by a lock ring 217. The lock ring 217, defining a hollow cylindrical piece of metal with two ends threaded on its inside wall, has the multidimensional shaft 206 swivelled in from the left side and the drum base 218 swivelled in from the right side. Due to these two components swivelling into the lock ring 217, the outer right end of the multidimensional shaft 206 and the outer left end of the drum base 218 are also threaded. As for concealing and securing the hollow cylindrical shield 210, two ends of the shield 210 are overlaid with bore covers 211. The layers of bore covers 211 are secured by cavity in the two different size bearings 209, 219 in FIG. 5 on each end.

Once a rotary scanner equipped with an integral motor of the present design's preferred embodiment is in a scanning process, power is supplied to the stator 207 coils. The magnetic field sensor 214 is used to detect the polarity of the rotor's 208 magnetic field generated by the permanent magnet. Then, by identifying the polarity of the sensed magnetic field, the magnetic field sensor 214 initiates the stator 208 to generate a correlated magnetic field. As the multidimensional shaft 206 rotates about its center at high speed, pads are required as fillings between the base support and the multidimensional shaft 206 to eliminate the rotational friction damages. These pads are the bearings 209, 219 and are locate at the two ends of the multidimensional shaft 206.

It should be apparent that the preceding description illustrates the current invention in one embodiment only and the invention is not restricted to the preferred embodiment. It should also be evident to those skilled in that art that variations and modifications to the preferred embodiment are possible without departing from the spirit and scope of the design. In particular, it should be understood that the invention can embody a multidimensional shaft 206 positioned in any direction and the number of different diameters on the multidimensional shaft 206 are not limited to the described preferred embodiment.

What is claimed is:

1. An integral motor providing rotational force to the rotary drum of a rotary scanner in order for the optical system of said rotary scanner to sample the original mounted on said rotary drum comprising of:
a multidimensional shaft aligning precisely with said rotary drum with numerous diameters for said rotational force to be directly generated onto;
a drum base defining the transition element between said multidimensional shaft and said rotary drum;
a lock ring defining the linkage element to connect said multidimensional shaft to said drum base;
driving components defining mechanics to generate said rotational force directly onto said multidimensional shaft;
padding means defining fillings between said multidimensional shaft and said supporting means to eliminate rotational friction damages; and
a shield defining a hollow cylindrical shell for said integral motor.

2. The integral motor according to claim 1 wherein said lock ring is a hollow cylindrical form with both ends threaded for said multidimensional shaft to swivel in from one end and said drum base to swivel in from another end.

3. The integral motor according to claim 1 wherein said drum base and said multidimensional shaft have one end threaded for swivelling in said lock ring.

4. The integral motor according to claim 1 wherein said driving components comprising of:
a rotor defining an arrangement of permanent magnets to attach to said multidimensional shaft's center circumference;
a stator defining an arrangement of coils to attach to the inside circumference of said shield aligning with said rotor; and
a magnetic field sensor defining a device to detect the surrounding magnetic field to attach to said stator.

5. The integral motor according to claim 1 wherein said padding means comprises two different size bearings mounted between said multidimensional shaft ends and said supporting means.

6. The integral motor according to claim 1 wherein:
all numerous dimensions of said multidimensional shaft are at the same center point;
said drum base aligns center point to center point with said multidimensional shaft;
all said padding means aligns center point to center point with said multidimensional shaft;
said shield aligns center point to center point with said multidimensional shaft; and
all said driving components align center point to center point with said multidimensional shaft.

7. The integral motor according to claim 1 wherein said integral motor component's edges is parallel with said multidimensional shaft's edges between said numerous diameters.

8. The integral motor according to claim 7 wherein said multidimensional shaft's edges are generated by the slopes of the increment between said numerous diameters of said multidimensional shaft, and all these said edges are in right angles meaning all said slopes approach infinity.

9. The integral motor according to claim 8 wherein said drum base, said driving components and said padding means align precisely with said multidimensional shaft by fitting to the said right-angled edges between said numerous diameters.

10. The integral motor according to claim 1 further comprises:
supporting means defining a structure for stabilizing and securing said integral motor onto a base; and
bore covers for providing concealments at the ends of said shield.

11. The integral motor according to claim 10 wherein said supporting means comprises two L-shaped brackets with one side of each said bracket mounted to one of said bore covers and the other side mounted to said base.
